(19) United States
(12) Patent Application Publication
(10) Pub. No.: US 2023/0133617 A1
(43) Pub. Date: May 4, 2023

(54) BUMP DETECTOR

(71) Applicant: RADIO FLYER INC., Chicago, IL (US)

(72) Inventor: Daniel R. GREENBERG, Chicago, IL (US)

(21) Appl. No.: 17/975,744

(22) Filed: Oct. 28, 2022

Related U.S. Application Data
(60) Provisional application No. 63/273,280, filed on Oct. 29, 2021.

(51) Int. Cl. G01D 5/14; A63G 25/00; B60R 16/02

(52) U.S. Cl. CPC G01D 5/14; A63G 25/00; B60R 16/02

(57) ABSTRACT

A bump detector system for a ride-on vehicle is provided. The bump detector system uses an extended length inner collapsible member having a first surface and a second surface. The inner collapsible member has a plurality of through holes spaced about its extended length. A first outer conductive member is secured to the first surface of the inner collapsible member and extends over the plurality of through holes, and a second outer conductive member is secured to the second surface of the inner collapsible member and extends over the plurality of through holes. The bumper of the ride-on vehicle has a recess that is sized to receive the inner collapsible member, first outer conductive member and second outer conductive member.

### CROSS-REFERENCE TO RELATED APPLICATIONS

This application claims the benefit of U.S. Provisional Patent Application No. 63/273,280 filed Oct. 29, 2021, which is expressly incorporated herein by reference and made a part hereof.

### FEDERALLY SPONSORED RESEARCH OR DEVELOPMENT

Not Applicable.

### TECHNICAL FIELD

The present subject matter relates to a detector, and more particularly, to a detector that detects contact with a bumper of a ride-on toy.

### BACKGROUND

Bump detection systems are known in the art. While such products according to the prior art provide a number of advantages, they nevertheless have certain limitations. The present disclosure seeks to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates to a bump detector system for a ride-on vehicle.

The disclosed technology further relates to a bump detector system for a ride-on vehicle comprising: an inner collapsible member having a first surface and a second surface, wherein the inner collapsible member has an extended length, and wherein the inner collapsible member has a plurality of through holes spaced about its extended length, the plurality of through holes extending from the first surface of the inner collapsible member through to the second surface of the inner collapsible member; a first outer conductive member secured to the first surface of the inner collapsible member and extending over the plurality of through holes in the inner collapsible member; a second outer conductive member secured to the second surface of the inner collapsible member and extending over the plurality of through holes in the inner collapsible member; a first wire electrically connected to the first outer conductive member; a second wire electrically connected to the second outer conductive member; a bumper having a recess therein, the recess sized to receive the inner collapsible member, first outer conductive member and second outer conductive member, wherein the inner collapsible member, first outer conductive member and second outer conductive member are secured within the recess, and wherein the bumper is secured to a housing of the ride-on vehicle; and, a control system, the first and second wire each being electrically connected to the control system.

The disclosed technology further relates to a bump detector system for a ride-on vehicle comprising: an inner collapsible member having a first surface and a second surface, wherein the inner collapsible member has an extended length, and wherein the inner collapsible member has a plurality of through holes spaced about its extended length, the plurality of through holes extending from the first surface of the inner collapsible member through to the second surface of the inner collapsible member; a first outer conductive member secured to the first surface of the inner collapsible member and extending over the plurality of through holes in the inner collapsible member; a second outer conductive member secured to the second surface of the inner collapsible member and extending over the plurality of through holes in the inner collapsible member; a first wire electrically connected to the first outer conductive member; a second wire electrically connected to the second outer conductive member; and, a control system, the first and second wire each being electrically connected to the control system.

The disclosed technology further relates to a bump detector system for a ride-on vehicle having a housing, the bump detector system comprising: an inner collapsible member having a first surface and a second surface, wherein the inner collapsible member has an extended length, and wherein the inner collapsible member has a plurality of through holes spaced about its extended length, the plurality of through holes extending from the first surface of the inner collapsible member through to the second surface of the inner collapsible member; a first outer conductive member secured to the first surface of the inner collapsible member and extending over the plurality of through holes in the inner collapsible member; a second outer conductive member secured to the second surface of the inner collapsible member and extending over the plurality of through holes in the inner collapsible member; and, a bumper having a recess therein, the recess sized to receive the inner collapsible member, first outer conductive member and second outer conductive member, wherein the inner collapsible member, first outer conductive member and second outer conductive member are retained within the recess, and wherein the bumper is secured to the housing of the ride-on vehicle.

The disclosed technology further relates to a bump detector system, wherein the bumper is made of a compressible material, wherein the bumper has an outer surface and an inner surface, the inner surface being adjacent the housing of the ride-on vehicle, and wherein the groove is adjacent the inner surface of the bumper.

The disclosed technology further relates to a bump detector system, wherein the inner collapsible member, first outer conductive member and second outer conductive member are retained within the groove of the bumper with an adhesive.

The disclosed technology further relates to a bump detector system, further comprising a first lead connected to the first conductive member, and a second lead connected to the second conductive member, the first wire being connected to the first lead and the second wire being connected to the second lead.

The disclosed technology further relates to a bump detector system, wherein the first wire is soldered to the first lead, and wherein the second wire is soldered to the second lead.

The disclosed technology further relates to a bump detector system, further comprising a bumper secured to a housing of the vehicle, the bumper having a recess therein, the recess sized to receive the inner collapsible member, first outer conductive member and second outer conductive member.

The disclosed technology further relates to a bump detector system, wherein the inner collapsible member, first outer conductive member and second outer conductive member are secured to the bumper within the recess.

The disclosed technology further relates to a bump detector system, wherein the bumper is made of a compressible material, wherein the bumper has an outer surface and an inner surface, the inner surface being adjacent the housing of the ride-on vehicle, and wherein the recess is adjacent the inner surface of the bumper.

The disclosed technology further relates to a bump detector system, wherein the inner collapsible member, first outer conductive member and second outer conductive member are retained within the recess of the bumper with an adhesive.

The disclosed technology further relates to a bump detector system, wherein the inner collapsible member extends around over 90% of a perimeter of a housing of the ride-on-vehicle.

The disclosed technology further relates to a bump detector system, further comprising a first wire electrically connected to the first outer conductive member, a second wire electrically connected to the second outer conductive member, and a control system, the first and second wire each being electrically connected to the control system.

The disclosed technology further relates to a bump detector system, wherein the bumper extends around a perimeter of the housing, and wherein the inner collapsible member extends over 90% of a length of the bumper.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1 is a front perspective view of a ride-on toy having a bumper and an internal bump detector, according to the present disclosure.

FIG. 2 is a top plan view of the ride-on toy of FIG. 1, according to the present disclosure.

FIG. 3 is a cross section view of the bumper and internal bump detector of FIG. 1, according to the present disclosure.

FIG. 4 is a perspective view of one embodiment of an bump detector system for use with the ride-on toy of FIG. 1, according to the present disclosure.

FIG. 5 is a schematic view of one embodiment of a bump detector system for use with the ride-on toy of FIG. 1, according to the present disclosure.

FIG. 6 is an end view of one embodiment of a portion of a bump detector system for use with the ride-on toy of FIG. 1, according to the present disclosure.

FIG. 7 is a side plan view of a portion of one embodiment of an inner collapsible member for a bump detector system for the ride-on toy of FIG. 1, according to the present disclosure.

FIG. 8 is a longitudinal cross-sectional view of a portion of an embodiment of a bump detector system for the ride-on toy of FIG. 1, according to the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

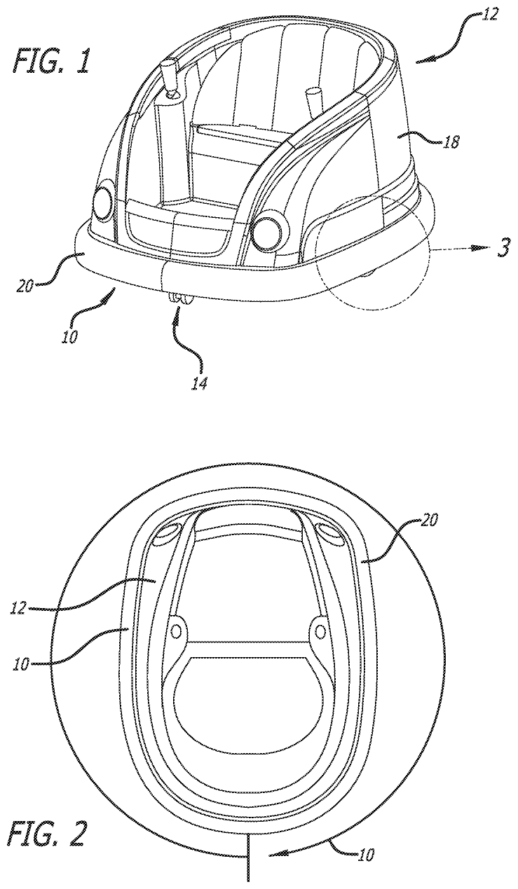

Generally, this disclosure describes various embodiments of bump detector system 10 for a ride-on vehicle 12. In one embodiment the ride-on toy 12 has a drive system 14, a control system 16, a housing 18, a bumper 20 and a bump detector system 10. As shown in FIGS. 1 and 2, the bump detector system 10 provides approximately a 360° contact-sensing system for the ride-on toy 12 that is more accurate and reliable than alternate sensing systems, including limit switches and vibration switches.

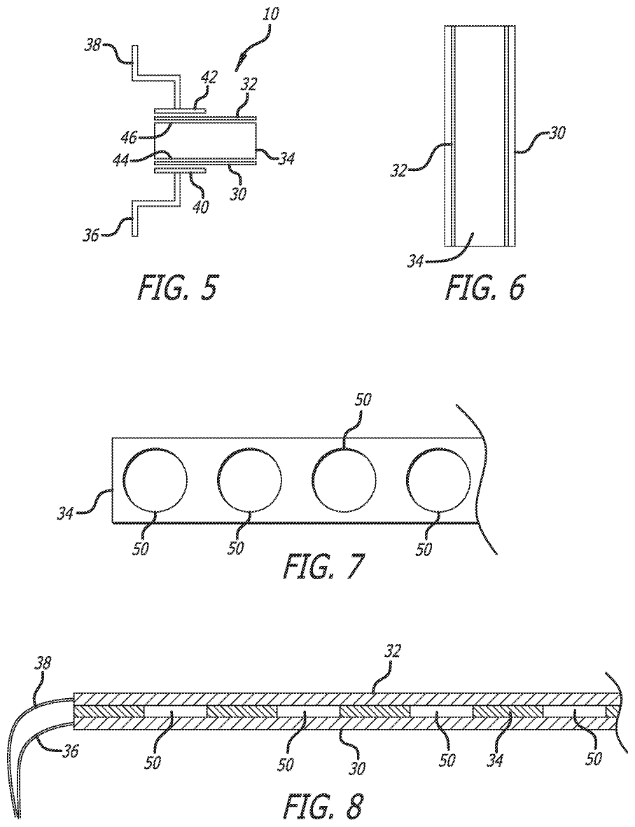

Referring to the figures, and initially to FIGS. 4-6 and 8, there is shown one embodiment of a bump detector system 10. In one embodiment, the bump detector system 10 comprises a first outer conductive member 30, a second outer conductive member 32, an inner collapsible member 34, a first wire 36 and a second wire 38. Preferably, the length of the bump detector system 10 is the full length of the bumper 20 of the ride-on vehicle 12, however, in alternate embodiments the bump detector system 10 may be shorter to provide bump detection in only certain desired areas of the ride-on vehicle 12. In one embodiment, the inner collapsible member 34 has a first surface 44 and a second surface 46, and has an extended length. As shown in FIG. 8, the first outer conductive member 30 is secured adjacent the first surface 44 of the inner collapsible member 34, such as with an adhesive, and extends over the plurality of through holes 50, and the second outer conductive member 32 is secured adjacent the second surface 46 of the inner collapsible member 34 and extends over the plurality of through holes 50. Depending on the construction of the outer conductive members, the bump detector system 10 may also have a first lead 40 on the first outer conductive member 30 to allow the first wire 36 to be secured to the first outer conductive member 30 via the first lead 40, and a second lead 42 on the second outer conductive member 32 to allow the second wire 38 to be secured to the second outer conductive member 32 via the second lead 42. In one embodiment, the first lead 40 is a copper tape that is secured to the first outer conductive member 30 and the first wire 36 is soldered to the first lead 40, and the second lead 42 is similarly a copper tape that is secured to the second outer conductive member 32 and the second wire 38 is soldered to the second lead 42. Alternately, the wires may be secured directly to the conductive members. Additionally, in one embodiment, one of the first outer conductive member 30 and the second outer conductive member 32 is referred to as a positive electrode, and the other of the first outer conductive member 30 and the second outer conductive member 32 is referred to as a negative electrode. Further, in one embodiment the first and second conductive members 30, 32 may be made of an extruded material, such as a PET (polyethylene terephthalate) with a conductive material therein.

Referring to FIGS. 7 and 8, in one embodiment the inner collapsible member 34 is a foam member, including such as a foam TPU (thermoplastic polyurethane). And, in one embodiment the inner collapsible member 34 has a plurality of through holes 50 spaced about its extended length. In one embodiment, the plurality of through holes 50 extend from the first surface 44 of the inner collapsible member 34 through to the second surface 46 of the inner collapsible member 34. As shown in FIG. 7, in one embodiment the foam member 34 is approximately 5 mm thick and 16 mm tall. The length of the inner collapsible member 34 depends on the desired length of the bump detector system 10 and the desired use thereof. In one embodiment the through holes 50 are approximately 12 mm in diameter, and the through holes 50 are spaced approximately every 18 mm, however, it is understood that the through holes 50 may be different sizes and may be spaced differently based on a variety of factors. In a preferred embodiment, the inner collapsible member 34 is flexible and compressible.

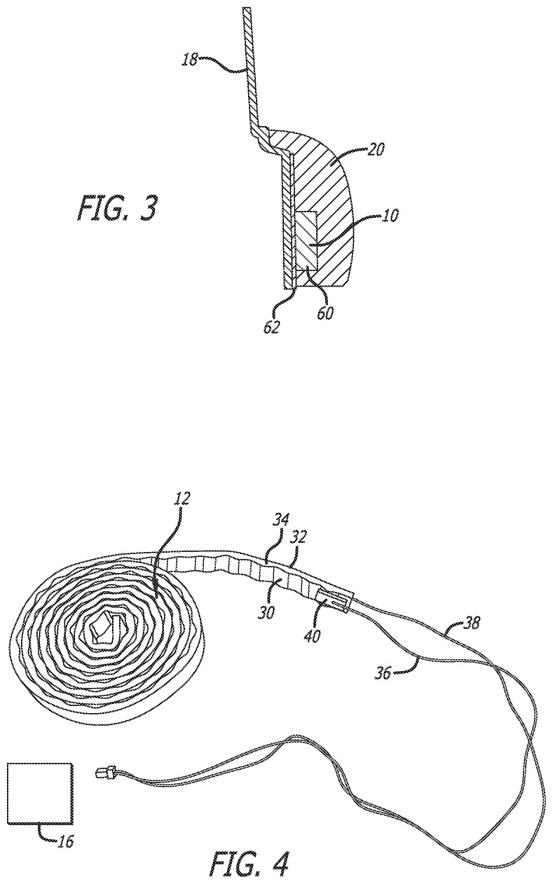

As shown in the cross-sectional view of FIG. 3, in one embodiment of the ride-on toy 12, the bumper 20 of the ride-on toy 12 is made of a compressible material, such as a rubber. The bumper 20 has a groove 60 or recess 60 that is sized to receive the inner collapsible member 34, first outer conductive member 30 and second outer conductive member 32. The inner collapsible member 34, first outer conductive member 30 and second outer conductive member 32 are assembled and inserted into the recess 60 in the bumper 20 and secured in place, such as with an adhesive or tape 62. In one embodiment, the tape 62 is a double-sided tape such that the bumper 20, having the bump detector system 10 secured in the recess 60 thereof, is then secured via the tape 62 to the housing 18 of the ride-on toy 12. The wires 36, 38 are then connected to the control system 16 of the ride-on toy 12. Further, in one embodiment, as shown in FIG. 2, the bumper 20 and bump detector system 10 is provided around the entire ride-on vehicle, provide 360° of bump detection. In a preferred embodiment, the inner collapsible member 34 extends around over 90% of a perimeter of the housing of the ride-on vehicle as shown in FIG. 2. Further, in one embodiment, the bumper 20 extends around a perimeter of the housing and the inner collapsible member 34 extends over 90% of a length of the bumper 20.

In operation of the bump detector system 10, when the ride-on vehicle contacts an obstacle the bumper 20 is compressed. When the bumper 20 is compressed the bump detector system 10 within the groove 60 of the bumper 20 will similarly be compressed, thereby squeezing together the first outer conductive member 30 and the second outer conductive member 32. Because the inner collapsible member 34 has a plurality of through holes 50, the two outer conductive members 30, 32 will contact each other through the appropriate through hole 50 adjacent the contact with the obstacle, thereby connecting the positive and negative electrodes and proving a signal to the control system 16 via the wires 36, 38. When the signal is received by the control system 16, different effects may occur. For example, the vehicle 12 may stop for a period of time and play music, the vehicle may react with movements and/or sound, an alarm may be set off, etc.

The embodiments detailed hereinabove may be combined in full or in part, with any alternative embodiments described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the present disclosure may be embodied in other specific forms without departing from the spirit or central characteristics thereof. The present examples and embodiments, therefore, are to be considered in all respects as illustrative and not restrictive, and the Claims are not to be limited to the details given herein. Accordingly, while the specific embodiments have been illustrated and described, numerous modifications come to mind without significantly departing from the spirit of the disclosure and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A bump detector system for a ride-on vehicle comprising:
an inner collapsible member having a first surface and a second surface, wherein the inner collapsible member has an extended length, and wherein the inner collapsible member has a plurality of through holes spaced about its extended length, the plurality of through holes extending from the first surface of the inner collapsible member through to the second surface of the inner collapsible member;
a first outer conductive member secured to the first surface of the inner collapsible member and extending over the plurality of through holes in the inner collapsible member;
a second outer conductive member secured to the second surface of the inner collapsible member and extending over the plurality of through holes in the inner collapsible member;
a first wire electrically connected to the first outer conductive member;
a second wire electrically connected to the second outer conductive member;
a bumper having a recess therein, the recess sized to receive the inner collapsible member, first outer conductive member and second outer conductive member, wherein the inner collapsible member, first outer conductive member and second outer conductive member are secured within the recess, and wherein the bumper is secured to a housing of the ride-on vehicle; and,
a control system, the first and second wire each being electrically connected to the control system.

2. The bump detector system of claim 1, wherein the bumper is made of a compressible material, wherein the bumper has an outer surface and an inner surface, the inner surface being adjacent the housing of the ride-on vehicle, and wherein the groove is adjacent the inner surface of the bumper.

3. The bump detector system of claim 1, wherein the inner collapsible member, first outer conductive member and second outer conductive member are retained within the groove of the bumper with an adhesive.

4. The bump detector system of claim 1, further comprising a first lead connected to the first conductive member, and a second lead connected to the second conductive member, the first wire being connected to the first lead and the second wire being connected to the second lead.

5. The bump detector system of claim 4, wherein the first wire is soldered to the first lead, and wherein the second wire is soldered to the second lead.

6. A bump detector system for a ride-on vehicle comprising:
an inner collapsible member having a first surface and a second surface, wherein the inner collapsible member has an extended length, and wherein the inner collapsible member has a plurality of through holes spaced about its extended length, the plurality of through holes extending from the first surface of the inner collapsible member through to the second surface of the inner collapsible member;
a first outer conductive member secured to the first surface of the inner collapsible member and extending over the plurality of through holes in the inner collapsible member;
a second outer conductive member secured to the second surface of the inner collapsible member and extending over the plurality of through holes in the inner collapsible member;
a first wire electrically connected to the first outer conductive member;
a second wire electrically connected to the second outer conductive member; and,
a control system, the first and second wire each being electrically connected to the control system.

7. The bump detector system of claim 6, further comprising a bumper secured to a housing of the vehicle, the bumper having a recess therein, the recess sized to receive the inner collapsible member, first outer conductive member and second outer conductive member.

8. The bump detector system of claim 7, wherein the inner collapsible member, first outer conductive member and second outer conductive member are secured to the bumper within the recess.

9. The bump detector system of claim 7, wherein the bumper is made of a compressible material, wherein the bumper has an outer surface and an inner surface, the inner surface being adjacent the housing of the ride-on vehicle, and wherein the recess is adjacent the inner surface of the bumper.

10. The bump detector system of claim 7, wherein the inner collapsible member, first outer conductive member and second outer conductive member are retained within the recess of the bumper with an adhesive.

11. The bump detector system of claim 6, further comprising a first lead connected to the first conductive member, and a second lead connected to the second conductive member, the first wire being connected to the first lead and the second wire being connected to the second lead.

12. The bump detector system of claim 11, wherein the first wire is soldered to the first lead, and wherein the second wire is soldered to the second lead.

13. The bump detector system of claim 6, wherein the inner collapsible member extends around over 90% of a perimeter of a housing of the ride-on-vehicle.

14. A bump detector system for a ride-on vehicle having a housing, the bump detector system comprising:
an inner collapsible member having a first surface and a second surface, wherein the inner collapsible member has an extended length, and wherein the inner collapsible member has a plurality of through holes spaced about its extended length, the plurality of through holes extending from the first surface of the inner collapsible member through to the second surface of the inner collapsible member;
a first outer conductive member secured to the first surface of the inner collapsible member and extending over the plurality of through holes in the inner collapsible member;
a second outer conductive member secured to the second surface of the inner collapsible member and extending over the plurality of through holes in the inner collapsible member; and,
a bumper having a recess therein, the recess sized to receive the inner collapsible member, first outer conductive member and second outer conductive member, wherein the inner collapsible member, first outer conductive member and second outer conductive member are retained within the recess, and wherein the bumper is secured to the housing of the ride-on vehicle.

15. The bump detector system of claim 14, further comprising a first wire electrically connected to the first outer conductive member, a second wire electrically connected to the second outer conductive member, and a control system, the first and second wire each being electrically connected to the control system.

16. The bump detector system of claim 14, wherein the bumper extends around a perimeter of the housing, and wherein the inner collapsible member extends over 90% of a length of the bumper.

17. The bump detector system of claim 14, wherein the bumper is made of a compressible material, wherein the bumper has an outer surface and an inner surface, the inner surface being adjacent the housing of the ride-on vehicle, and wherein the recess is adjacent the inner surface of the bumper.

18. The bump detector system of claim 14, wherein the inner collapsible member, first outer conductive member and second outer conductive member are retained within the recess of the bumper with an adhesive.

19. The bump detector system of claim 15, further comprising a first lead connected to the first conductive member, and a second lead connected to the second conductive member, the first wire being connected to the first lead and the second wire being connected to the second lead.

20. The bump detector system of claim 19, wherein the first wire is soldered to the first lead, and wherein the second wire is soldered to the second lead.
